(19) United States
(12) Patent Application Publication
(10) Pub. No.: US 2013/0188758 A1
(43) Pub. Date: Jul. 25, 2013

(54) JOINT SOURCE CHANNEL DECODING USING PARAMETER DOMAIN CORRELATION

(71) Applicant: BROADCOM CORPORATION, Irvine, CA (US)

(72) Inventor: Robert W. Zopf, Rancho Santa Margarita, CA (US)

(73) Assignee: BROADCOM CORPORATION, Irvine, CA (US)

(21) Appl. No.: 13/748,904

(22) Filed: Jan. 24, 2013

Related U.S. Application Data
(60) Provisional application No. 61/752,320, filed on Jan. 14, 2013.
(60) Provisional application No. 61/706,328, filed on Sep. 27, 2012.
(60) Provisional application No. 61/590,015, filed on Jan. 24, 2012.

(51) Int. Cl. H04L 1/22

(52) U.S. Cl. CPC H04L 1/22
USPC 375/343

(57) ABSTRACT

Methods, systems, and apparatuses are provided for performing joint source channel decoding in a manner that exploits parameter domain correlation. Redundancy in speech coding and packet field parameters is exploited to generate conditional probabilities that a decoder utilizes to perform joint source channel decoding. The conditional probabilities are based upon correlations of parameters of a current frame with parameters of the same or other frames or historical parameter data. Parameter domain correlation provides significant channel decoding improvement over prior bit domain solutions. Also provided are methods, systems, and apparatuses for utilizing received statistics of monitored data bits from which conditional probabilities are generated to perform channel decoding. The techniques described may be implemented at the decoder side and thus do not interfere with transmission standards.

### CROSS-REFERENCE TO RELATED APPLICATIONS

This application claims priority to the following provisional applications, each of which is incorporated by reference herein: U.S. Provisional Patent Application No. 61/590,015, filed Jan. 24, 2012, U.S. Provisional Patent Application No. 61/706,328, filed Sep. 27, 2012, and U.S. Provisional Patent Application No. 61/752,320, filed Jan. 14, 2013.

This application is also related to the following U.S. Patent Applications, each of which also claims the benefit of U.S. Provisional Patent Application Nos. 61/590,015 and 61/706,328, and each of which is incorporated by reference herein:
U.S. patent application Ser. No. ______ (Attorney Docket No. A05.01900001), filed on even date herewith and entitled “Modem Architecture for Joint Source Channel Decoding”;
U.S. patent application Ser. No. ______ (Attorney Docket No. A05.01910001), filed on even date herewith and entitled “Modified Joint Source Channel Decoder”; and
U.S. patent application Ser. No. ______ (Attorney Docket No. A05.01920001), filed on even date herewith and entitled “Constrained Soft Decision Packet Loss Concealment.”

### BACKGROUND

1. Technical Field

The subject matter described herein relates to systems and methods for performing joint source channel decoding.

2. Background Art

The concept of channel capacity was introduced in C. E. Shannon, “A Mathematical Theory of Communication,” Bell System Technical Journal, vol. 27, pp. 379-423 and 623-656, July and October, 1948. In this work, Shannon stated that a source with entropy H can be reliably transmitted over a channel with capacity C as long as H<=C. Shannon also introduced the Separation Theorem which stated that the maximum capacity is achievable by treating the source and channel independently. In accordance with this model, and referring to FIG. 1, a source coder is first applied to reduce the rate down to H, and a channel code is subsequently applied (e.g., in a system 102). At the receiver, the channel decoder is unaware of the type of source and outputs the most probable codeword (e.g., in the system 102). The source decoder then reconstructs the source without any knowledge of the source statistics (e.g., in the system 102).

However, Shannon's Separation Theorem only holds true in the case of infinite complexity and delay, as well as a non time varying (AWGN) channel. When operating with finite complexity and delay on a channel that may vary in time (fading), better performance is generally achievable by jointly optimizing the source and channel coder. In Joint Source-Channel Coding (JSCC), the source and channel are jointly encoded, while in Joint Source-Channel Decoding (JSCD), the source and channel are jointly decoded. These cases are depicted in FIG. 1 as systems 104 and 106, respectively. Of course, a system may also employ both JSCC and JSCD. However, most communications systems employed to date either do not employ any JSCC or only employ very little JSCC. Significant gains can still be achieved in these systems by incorporating JSCD.

JCSD methods may exploit certain sources of redundancy in order to achieve improved performance. For example, in T. Hindelang et al., “Combined Source/Channel (De-) Coding: Can A Priori Information Be Used Twice?”, IEEE International Conference on Communications, 2000, pp. 1208-1212, the authors describe a method by which correlation between individual source bits in the same frame (intraframe correlation) and/or different frames (inter-frame correlation) can be utilized to achieve improved performance. However, this approach, which exploits correlation in the bit domain only, can only provide a limited amount of improvement.

### BRIEF SUMMARY

Methods, systems, and apparatuses are described for performing joint source channel decoding in a manner that exploits parameter domain correlation, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of systems with various encoding and decoding implementations.

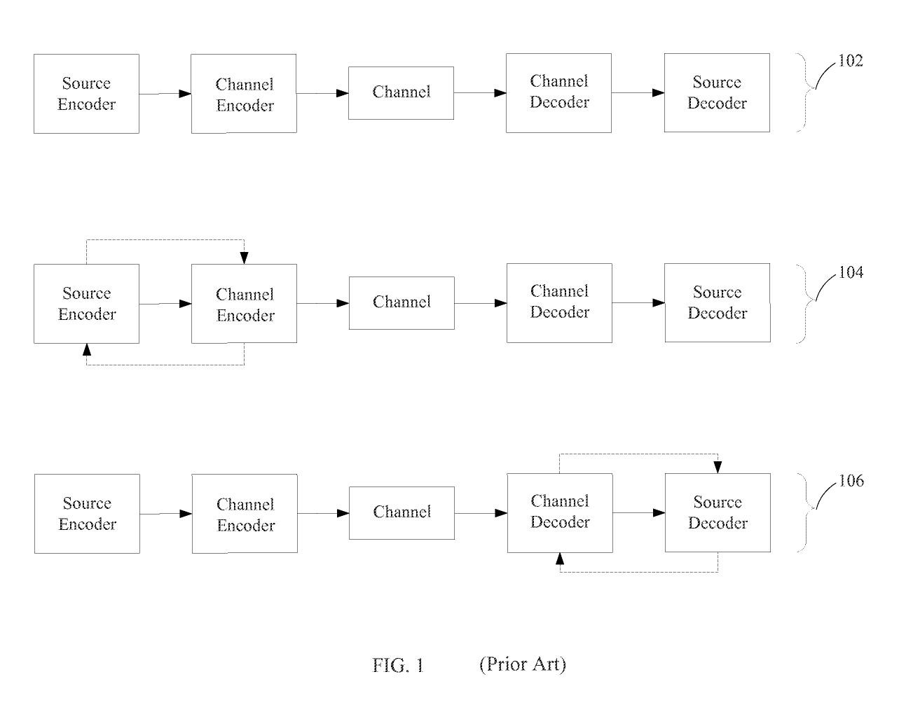

FIG. 2 is a block diagram of a portion of a long term evolution standard receiver architecture, according to an exemplary embodiment.

FIG. 3 is a block diagram of a portion of a JSCD block adapted to perform joint source channel decoding, according to another exemplary embodiment.

FIG. 4 is a flowchart providing example steps for performing joint source channel decoding using parameter-based correlation, according to an exemplary embodiment.

FIG. 5 is a flowchart providing example steps for performing joint source channel decoding using parameter-based correlation, according to an exemplary embodiment.

FIG. 6 is a block diagram of a computer system, according to an exemplary embodiment.

FIG. 7 is a flowchart providing example steps for performing joint source channel decoding using received statistics, according to an exemplary embodiment.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### 1. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, terminology used herein to refer to decoder decisions and other information as “hard” refers to whether the decision or information represents actual, perceived data bits (e.g., a ‘1’ (logical high signal value) or a ‘0’ (logical low signal value)). The “hard” values are the actual data bits and/or what a decoder has determined the actual data bits to be. Terminology used herein to refer to decoder decisions and other information as “soft” refers to whether the decision or information are representations of the probability (e.g., conditional probability) and/or the likelihood of a given bit in the data stream being a ‘1’ or a ‘0’. “Soft bits,” for example, may be represented as a decimal number with a theoretical range between 0 and 1 (e.g., 0.2138 or 0.9853) for a probability, where a value less than 0.5 indicates a likelihood of the actual data bit (i.e., “hard bit”) being a ‘0’, while a value greater than 0.5 indicates a likelihood of the actual data bit (i.e., “hard bit”) being a ‘1’ (a value of 0.5 indicates an equal probability of ‘0’ or ‘1’). Similarly, a “soft bit” value may theoretically range from −∞ (negative infinity) to +∞ (positive infinity) for a log likelihood ratio (LLR), where a value less than zero indicates a likelihood of a ‘0’, a value greater than zero indicates a likelihood of a ‘1’, and a value of zero indicates an equal likelihood of a ‘0’ or a ‘1’. For probabilities and LLRs, the probabilities and likelihoods are stronger for a given data stream bit value (a ‘1’ or a ‘0’) as a probability or LLR approaches the theoretical limits (high or low) of their respective ranges.

Still further, references in the specification to “extrinsics,” “extrinsic data,” or “extrinsic information” refer to information derived from redundant information in the code (e.g., data and parity bits, and/or the like). “Extrinsic information” is used by decoders to facilitate channel decoding, as described herein.

Still further, terminology used herein such as “about,” “approximately,” and “substantially” have equivalent meanings and may be used interchangeably.

Numerous exemplary embodiments are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner.

### 2. Example Embodiments

The examples described herein may be adapted to various types of wired and wireless communications systems, computing systems, communication devices, and/or the like, which include encoders and/or decoders. Furthermore, additional structural and operational embodiments, including modifications/alterations, will become apparent to persons skilled in the relevant art(s) from the teachings herein.

In embodiments, communication systems may be based on the Long Term Evolution (LTE) IP-based standard for wireless data communications. LTE provides high access rates, low latencies, reduced data delivery costs, and simplification of network architecture. Such embodiments may also provide Voice over LTE (VoLTE) services that are implemented as Voice over Internet Protocol (VoIP), which is supported by the IP Multimedia Subsystem (IMS) with specific profiles for control and media planes of voice service defined by Global System for Mobile Communications Association (GSMA) in Permanent Reference Document (PRD) IR.92 titled “IMS Profile for Voice and SMS” (v4.0, Mar. 22, 2011) (hereinafter “IR.92”).

Communication system bandwidth used by data applications may in many cases be greater than the bandwidth for voice calls, but voice applications remain an important part of communication system utilization. It follows then that voice quality will remain a very important metric to consumers and companies which provide services and products. The embodiments described herein (e.g., for VoLTE) provide improved voice quality, decreased packet loss rates, and reduced channel noise for communication systems without undue decreases in network capacity and/or increased power consumption.

LTE communication systems may encode and decode data that is transmitted on communication channels using turbo coding. Example embodiments described herein based on turbo coding in LTE take advantage of joint source channel decoding (JSCD) as well as redundancies and correlations present in VoLTE. For example, data may be encoded using joint source channel coding (JSCC). This particular type of encoder may be paired with a JSCD turbo decoder for decoding purposes.

In JSCC, the source (e.g., speech related data) and the channel (e.g., packet related data) are jointly encoded, while in JSCD, the source and the channel are jointly decoded. Embodiments described herein may implement JSCD even if the source and channel are not jointly encoded. JSCD as described in the example embodiments may allow for an optimized channel capacity while providing joint decoding benefits such as improved communication efficiency, data integrity, and performance as well as adherence to VoLTE standards.

Turbo decoding generates a “soft bit” decision representation of the data bits in a data stream that represents the likelihood of a given bit in the data being a logical “1” or a logical “0”. These likelihoods may be presented as a ratio of probabilities, as will be discussed in further detail below. In example embodiments, a turbo decoder may include two or more decoders which work cooperatively in order to refine and improve the estimate of the original data bits over one or more iterations until the soft decisions converge on a stable set of values or until the preset maximum number of iterations is reached. The decoders may be based on the MAP (maximum a-posteriori probability) algorithm and may output the soft decision information determined from received data and corresponding parity bits. The converged soft decisions may then be used to recover the original binary data sequence.

Embodiments presented herein improve JSCD by exploiting parameter-based (parameter domain) correlation. The embodiments presented herein may exploit parameter domain correlation with respect to various types of parameters in voice data packets, such as, but not limited to speech coding parameters and packet header parameters.

For instance, methods, systems, and apparatuses are provided for exploiting parameter domain correlation in joint source channel decoding. In an example aspect, a method is disclosed. The example method is for performing joint source channel decoding. The method includes receiving a first plurality of soft bits representative of a first parameter included in a frame, each soft bit of the first plurality of soft bits specifying a probability that a corresponding bit of the first parameter is a zero or a one. The method also includes generating a second plurality of soft bits representative of the first parameter based on the first plurality of soft bits and at least one conditional probability based on a correlation of the first parameter and one or more other parameters included in the first frame and/or one or more parameters included in other frames, each soft bit of the second plurality of soft bits specifying a probability that a corresponding bit of the first parameter is a zero or a one. The method further includes providing the second plurality of soft bits to a first channel decoder.

In another example aspect, a system is disclosed that includes a first channel decoder and a packet redundancy analyzer. The packet redundancy analyzer is configured to receive a first plurality of soft bits representative of a first parameter included in a frame, each soft bit of the first plurality of soft bits specifying a probability that a corresponding bit of the first parameter is a zero or a one. The packet redundancy analyzer is also configured to generate a second plurality of soft bits representative of the first parameter based on the first plurality of soft bits and at least one conditional probability based on a correlation of the first parameter and one or more other parameters included in the first frame and/or one or more parameters included in other frames, each soft bit of the second plurality of soft bits specifying a probability that a corresponding bit of the first parameter is a zero or a one. The packet redundancy analyzer is also configured to provide the second plurality of soft bits to the first channel decoder.

In yet another example aspect, a method for performing joint source channel decoding is disclosed. The method includes monitoring first data bits received over a channel and generating one or more received statistics based on the monitored first data bits. The method also includes generating a conditional probability based exclusively on the one or more received statistics. The method further includes utilizing the conditional probability to perform channel decoding of second data bits received over the channel.

Various example embodiments are described in the following subsections. In particular, an example LTE architecture embodiment is described, followed by an example embodiments for JSCD and JSCD embodiments that exploit parameter domain correlation. JSCD embodiments that exploit speech coding parameter correlation and packet header parameter correlation are subsequently described. This is followed by a description of further example JSCD advantages and embodiments. Next, an example operational embodiment is described. Finally, an example computer-implemented embodiment is described.

### 3. Example LTE Architecture Embodiment

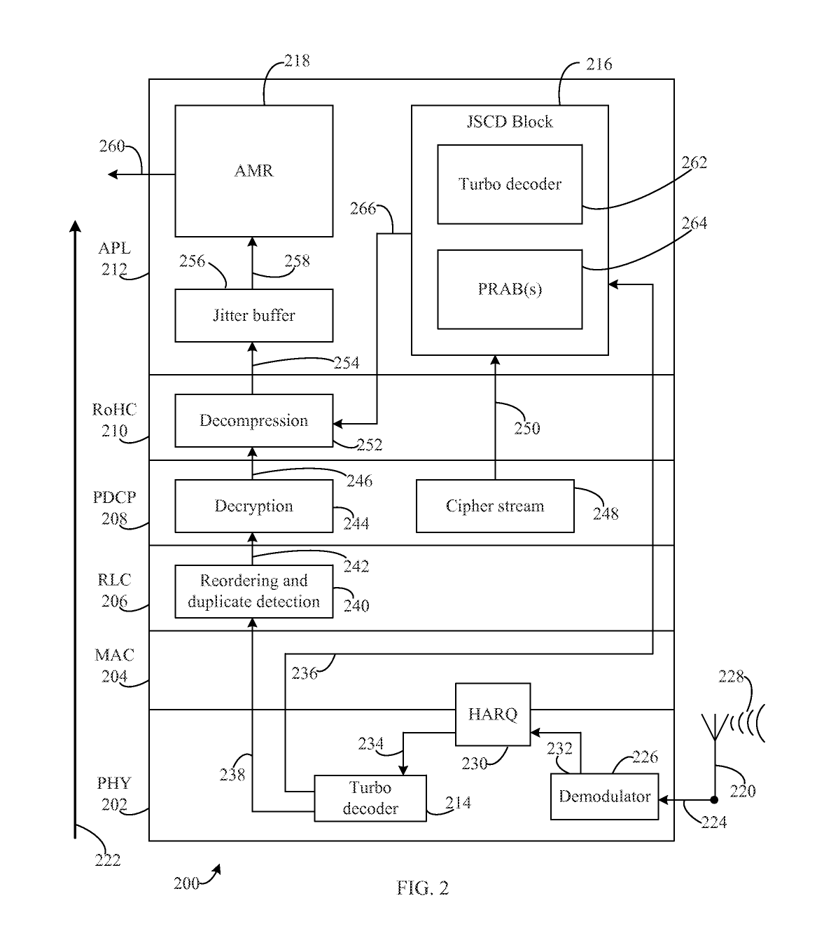

An LTE receiver, e.g., an LTE modem, in a communication system may be configured in various ways to decode received data streams utilizing JSCD, in embodiments. For example, FIG. 2 shows a block diagram of an LTE modem architecture (hereinafter “LTE architecture”) 200, according to an embodiment. LTE architecture 200 includes circuitry corresponding to the layers associated with the LTE protocol. The layers include a physical (PHY) layer 202, a medium access control (MAC) layer 204, a radio link control (RLC) layer 206, a packet data convergence protocol (PDCP) layer 208, a robust header compression (RoHC) layer 210, and an application (APL) layer 212. LTE architecture 200 also includes a first turbo decoder 214 in PHY layer 202, a JSCD block 216 in APL layer 212 as shown, an adaptive multi-rate speech decoder (hereinafter, “AMR”) 218 in APL layer 212, and an antenna 220. LTE architecture 200 and each of the components included therein may include functionality and connectivity beyond what is shown in FIG. 2, as would be apparent to persons skilled in relevant art(s). However, such additional functionality is not shown in FIG. 2 for the sake of brevity.

As shown in FIG. 2, an arrow 222 indicates the general flow of the progression of data through the LTE protocol stack from PHY layer 202 to APL layer 212. It should be noted that the progression of data may deviate from the flow indicated by arrow 222 and that the LTE protocol stack may include fewer layers or additional layers (not shown).

The PHY layer 202 includes channel coding, error detection, modulation/demodulation, and/or other procedures to handle power control, multi-antenna operation, and/or the like. PHY layer 202 is based on orthogonal frequency division multiple access (OFDMA) for downlink communications and single carrier frequency division multiple access (SC-FDMA) for uplink communications. As shown, PHY layer 202 includes a demodulator 226, a Hybrid Automatic Repeat Request (HARQ) block 230, and first turbo decoder 214. Antenna 220 receives incoming data signals on a data channel 228 and transmits the received data signal to demodulator 226 via a line 224. Demodulator 226 demodulates the received data signal and transmits the demodulated data to HARQ block 230 via a line 232. HARQ block 230 may request a retransmission of a data packet if an error is detected in the data packet. If retransmission is completed or not required, the channel data is then transmitted to first turbo decoder 214 via a line 234. First turbo decoder 214 decodes the channel data (which is encrypted data) to generate “soft bits” and transmits the encrypted “soft bits” to APL layer 212 via a line 236. First turbo decoder 214 also decodes the channel data to generate “hard bits” (the decoded channel data bits received via the data stream, i.e., the logical “1” or logical “0” that the decoder has determined to be the actual data bits) and transmits the “hard bits” to MAC layer 204 via a line 238.

MAC layer 204 functions include the mapping and multiplexing of logical channels to transport channels. MAC layer 204 also handles the physical layer retransmissions (e.g., performed via HARQ block 230) which are applied to voice due to the low delay associated with voice packets. As shown, HARQ block 230 overlaps with MAC layer 204 as well as with PHY layer 202. That is, MAC layer 204 may control, in full or in part, the actual physical retransmission that occurs in PHY layer 202. Scheduling is also implemented in MAC layer 204 with priority handling to ensure a sufficient level of Quality of Service.

RLC layer 206 handles retransmissions and segmentation. As shown, RLC layer 206 includes reordering and duplicate detection block 240 which corrects out of order packet sequences and duplicate packets (e.g., caused by the core IP network). Data is transmitted from RLC layer 206 to PDCP layer 208 via a line 242.

PDCP layer 208 handles ciphering and decryption. As shown, PDCP layer 208 includes a decryption block 244 and a cipher stream block 248. Decryption block 244 uses a cipher to decode encrypted data passed from the lower layers (e.g., encrypted “hard bits” from first turbo decoder 214) and transmit the decoded data to RoHC layer 210 via a line 246. Cipher stream block 248 provides the cipher to APL layer 212, via a line 250, in order to allow applications and/or circuitry in APL layer 212 to properly decrypt encrypted data (e.g., encrypted “soft bits” provided to APL layer 212 via line 236).

RoHC layer 210 supports robust header compression as specified in 3^{rd} Generation Partnership Project Technical Specification (3GPP TS) 36.323, Internet Engineering Task Force (IETF) Request for Comments (RFC) 3095, and IETF RFC 4815. As shown, RoHC layer 210 includes a decompression block 252 which decompresses Internet Protocol (IP) packet headers for transmission to APL layer 212 via a line 254.

APL layer 212 supports applications and services such as data buffering and speech decoding. As shown, APL layer 212 includes a jitter buffer 256, JSCD block 216, and AMR 218. Jitter buffer 256 buffers voice data for delivery of the voice data to AMR 218 to allow for smooth output of decoded speech by AMR 218. In some embodiments, AMR 218 may be a narrow-band multi-rate speech decoder (AMR-NB). AMR 218 outputs decoded speech via a line 260.

JSCD block 216 includes a second turbo decoder 262 and a Packet Redundancy Analysis Block (PRAB) 264. JSCD block 216 also includes modules, blocks, circuitry, and/or applications for data storage (not shown), for encrypting and/or decrypting data (not shown), for performing data transformations on “soft bits” to pass between encrypted and decrypted domains (not shown), and for routing received “soft bits” within the JSCD block 216 based upon an indication of whether errors are present in a data packet or not (not shown). JSCD block 216 receives encrypted “soft bits” via line 236, and second turbo decoder 262 performs its decoding operations based on the received encrypted “soft bits” and based on extrinsic data inputs received from one or more PRAB modules in PRAB 264, discussed in further detail below.

The resulting decoded data based on the hard decision of second turbo decoder 262 is decrypted in JSCD block 216 and transmitted to decompression block 252 where the decrypted, decoded data is re-inserted into the data stream. It should be noted, however, that in various embodiments, the hard decision data output by turbo decoder 262 may be provided to different elements and/or layers depicted in LTE architecture 200.

Second turbo decoder 262 provides for an additional turbo decoder that runs in APL layer 212 (in addition to turbo decoder 214 that runs in PHY layer 202). Running in APL layer 212 allows the additional turbo decoder to be configurable and flexible in application without modifying or affecting performance of first turbo decoder 214 in PHY layer 202. For example, first turbo decoder 214 is agnostic with respect to source signal information within a given packet, but second turbo decoder 262 may be configured in APL layer 212 to utilize packet information to improve channel decoding. That is to say, first turbo decoder 214 performs conventional channel decoding operations, while second turbo decoder 262 is configured to perform JSCD utilizing packet information. LTE architecture 200 also provides for transparent layers through which “soft bits” generated by first turbo decoder 214 can be passed to APL layer 212 for use by JSCD block 216 and the elements therein. For example, if it is determined that a data packet is “good” (e.g., no errors), the “soft bits” may be provided to a Packet Redundancy Analysis Block(s) (PRABs) to update PRAB states, whereas if it is determined that a data packet is “bad” (e.g., it contains errors), the “soft bits” may be provided to perform JSCD in APL layer 212. Likewise, cipher stream block 248 can provide a cipher stream for use by JSCD block 216 in APL layer 212.

LTE architecture 200 and each of the elements included therein may be implemented in hardware, or a combination of hardware and software and/or firmware.

Further details concerning an example modem architecture that supports JSCD, such as that shown in FIG. 2 or alternative implementations thereof, may be found in commonly-owned co-pending U.S. patent application Ser. No. ______ (Attorney Docket No. A05.01900000), entitled “Modem Architecture for Joint Source Channel Decoding” and filed on even date herewith, the entirety of which is incorporated by reference as if fully set forth herein.

### 4. Example Joint Source Channel Decoder Embodiments

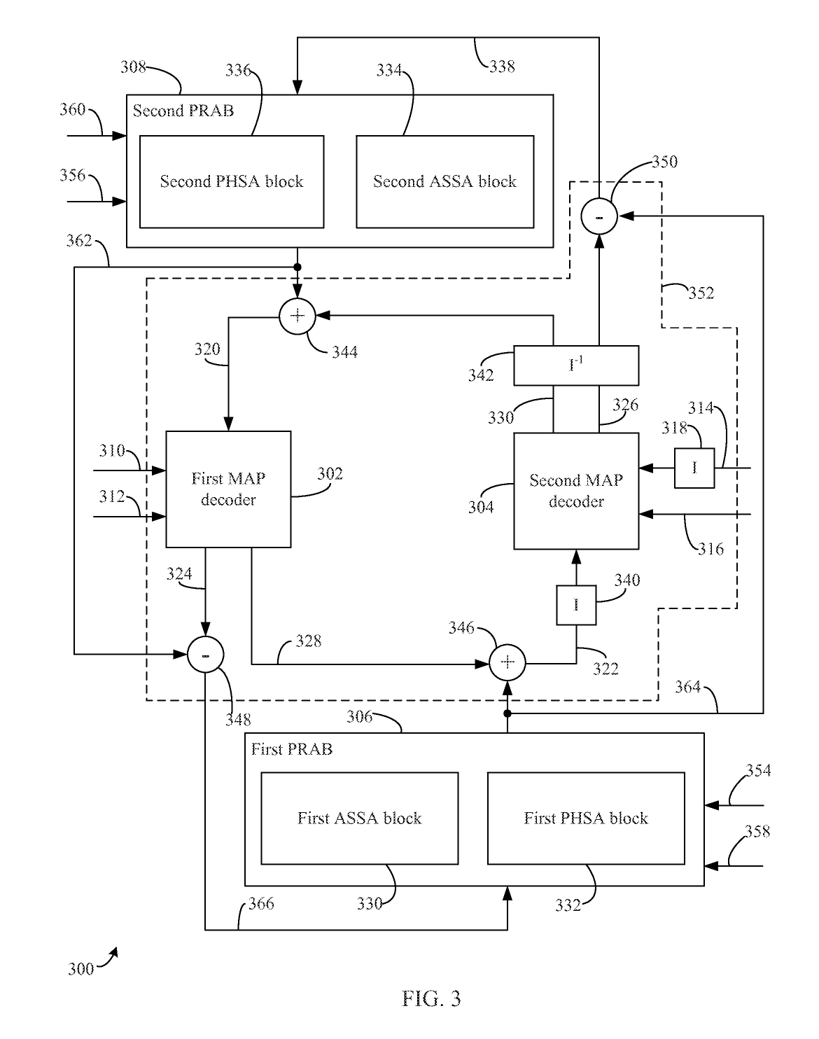

As noted in the above-described LTE architecture 200, a receiver may be configured in ways to perform joint source channel decoding (JSCD). For example, a joint source channel decoding embodiment using the Long Term Evolution (LTE) standard and turbo decoding is described in this section. Referring to FIG. 3, a block diagram of a portion of a JSCD block 300 adapted to perform joint source channel decoding is described, according to embodiments. JSCD block 300 may be a further embodiment of JSCD block 216 described with respect to FIG. 2 above.

JSCD block 300 functions by injecting a-priori information into each of a first Maximum A-posteriori (MAP) decoder (a non-interleaved MAP decoder) and second MAP decoder (an interleaved MAP decoder) of a modified turbo decoder. The first and second MAP decoders perform decoding to converge on a hard decision (representing the determination of the decoders of the actual data bits in a data packet) or until a predetermined number of iterations are performed. Certain prior art solutions perform JSCD by injecting a-priori information into only a non-interleaved MAP decoder. JSCD block 300, as illustrated in FIG. 3, avoids positive feedback of source statistics from one MAP decoder to the other by subtracting out extrinsic data of the source from the “soft bit” outputs of the MAP decoder (e.g., log likelihood ratios (LLRs) representing the “soft decision” of a MAP decoder with respect to whether a given bit in a data stream is likely to be a “1” or a “0”). The “soft bits” resulting from this subtraction are input to a Packet Redundancy Analysis Block which generates extrinsic information to be provided to the companion MAP decoder along with extrinsic information from the first MAP decoder. As such, JSCD block 300 performs JSCD by injecting a-priori information into both the first and second MAP decoders without feedback of source statistics. In practice, it has been observed that this doubles an improvement achievable when injecting a-priori information into only a non-interleaved MAP decoder.

As illustrated in FIG. 3, JSCD block 300 includes a turbo decoder 352 (shown with a dashed outline for illustrative purposes), a first Packet Redundancy Analysis Block (PRAB) 306, and a second PRAB 308. Turbo decoder 352 includes a first MAP decoder 302 and a second MAP decoder 304. Turbo decoder 352 also includes an interleaver block 318, and interleaver block 340, a de-interleaver block 342, an adder block 344, and adder block 346, a subtractor block 348, and a subtractor block 350. First PRAB 306 includes a first A-priori Speech Statistics Algorithm (ASSA) block 330 and a first Packet Header Statistics Algorithm (PHSA) block 332. Second PRAB 308 includes a second ASSA block 334 and a second PHSA block 336.

Turbo decoder 352 receives inputs including “soft” data bits and “soft” parity bits (e.g., from first turbo decoder 214 in PHY layer 202, as shown in FIG. 2) and extrinsic information from first and second PRABs 306/308. For example, first MAP decoder 302 receives “soft” data bits on line 310 and “soft” parity bits on line 312, while second MAP decoder 304 receives interleaved “soft” data bits on line 314 via interleaver block 318 (which interleaves the data) and “soft” parity bits on line 312. Turbo decoder 352 also receives extrinsic information as inputs from first PRAB 306 and second PRAB 308 via lines 362 and 364, respectively. Turbo decoder 352 provides, as output signals, “soft bits” (e.g., LLRs or “soft decisions”) to first PRAB 306 and second PRAB 308 via lines 366 and 338, respectively. First PRAB 306 and second PRAB 308 also receive “soft bits” as inputs (e.g., from first turbo decoder 214 in PHY layer 202, as shown in FIG. 2) via lines 354 and 356 respectively. First PRAB 306 and second PRAB 308 also receive, via lines 358 and 360 respectively, and/or store (e.g., in a memory (not shown) that is local to and/or external to JSCD block 300) a-priori probability information (e.g., reference data) and information from past, current, or future frames relating to parameter values.

In embodiments, first MAP decoder 302 provides first MAP “soft bits” (e.g., LLRs or “soft decisions”) via line 324 to subtractor block 348. Subtractor block 348 receives extrinsic information from second PRAB 308 via line 362 and subtracts the extrinsic information from the first MAP “soft bits.” The output of subtractor block 348 is provided to first PRAB 306 via line 366 as described above. Second MAP decoder 304 provides second MAP “soft bits” (e.g., LLRs or “soft decisions”) via line 326 and de-interleaver block 342 (which de-interleaves the data) to second PRAB 308 in a similar manner as first MAP decoder 302. That is, when second MAP decoder 304 provides the second MAP “soft bits” to second PRAB 308, the first PRAB extrinsic data is removed from the second MAP “soft bit” output at subtractor block 350, which also uses line 364 as an input, and the output of subtractor block 350 is provided to second PRAB 308 via line 338. Additionally, first MAP decoder 302 and second MAP decoder 304 provide their own respectively generated extrinsic data to each other as inputs. First MAP decoder 302 outputs extrinsic data via line 328 to adder block 346. Adder block 346 also takes extrinsic data from first PRAB 306 as an input via line 364. Adder block 346 outputs the combined extrinsic data to second MAP decoder 304 on line 322 via interleaver block 340 (which interleaves the data). Similarly, second MAP decoder 304 outputs extrinsic data, via line 330 and de-interleaver block 342 (which de-interleaves the data), to adder block 344. Adder block 344 also takes extrinsic data from second PRAB 308 as an input via line 362. Adder block 344 outputs the combined extrinsic data to first MAP decoder 302 on line 320. In this way, turbo decoder 352 prevents improper and/or premature convergence for its hard bit decisions.

In embodiments, first PRAB 306 and/or second PRAB 308, including their respective sub-components, may monitor incoming data bits received in one or more frames over a channel. The incoming data bits may be monitored in real-time or substantially in real-time in embodiments. First PRAB 306 and/or second PRAB 308, including their respective sub-components, may generate one or more received statistics based on the monitored data bits and may generate a conditional probability based exclusively on the received statistics. In embodiments, the received statistics may be one or more probabilities that incoming data bits are ones or zeroes based upon the received data bits. The generated conditional probability may be utilized (e.g., when provided to a decoder such as turbo decoder 352) to perform channel decoding of future bits received over the channel.

JSCD block 300 and each of the elements included therein may be implemented in hardware, or a combination of hardware and software and/or firmware. Additionally, in some embodiments it is contemplated that first PRAB 306 and second PRAB 308 may coexist in a single PRAB (not shown), or that a single PRAB may be configured in place of first PRAB 306 and second PRAB 308.

Further details concerning an example JSCD block with a modified turbo decoder architecture that supports JSCD, such as that shown in FIG. 3 or alternative implementations thereof, may be found in commonly-owned co-pending U.S. patent application Ser. No. ______ (Attorney Docket No. A05.01910000), entitled “Joint Source Channel Turbo Decoder” and filed on even date herewith, the entirety of which is incorporated by reference as if fully set forth herein.

The next section describes JSCD embodiments in the context of JSCD block 300 as described above and as shown in FIG. 3, in which parameter domain correlation of speech information is utilized to improve channel decoding. However, the JSCD techniques that will be described are not limited to that embodiment.

### 5. Example Embodiments for Joint Source Channel Decoding Using Parameter Domain Correlation

As noted above, in Joint Source Channel Decoding (JSCD), the source and channel are jointly decoded. JSCD may be performed in accordance with the embodiments described above. In accordance with embodiments described in this section, JSCD is performed using correlation of parameters within and associated with the data to improve decoding, unlike previous solutions which only utilized bit domain correlation. Correlation in the parameter domain is used to generate models (e.g., probability density functions (PDFs)) for parameters and/or parameter combinations. These models are then applied to update the “soft bit” values obtained for each parameter during channel decoding (e.g., turbo decoding in LTE).

Sources of redundancy in Voice over LTE (VoLTE) data packets may be generally described as follows. A residual redundancy incurred by encoding ρᵣ may be shown as:

ρ_{T}=R−Hₓ (1)

where R represents an encoding rate (in bits/symbol), and where Hₓ represents the minimum rate (in bits/symbol) at which the process can be encoded without incurring distortion. For redundancy in the AMR-NB (Adaptive Multi-Rate Narrowband) speech codec used in VoLTE, a stationary, first-order Markov chain may provide a probabilistic model. The total redundancy may be broken into two terms:

ρ_{T}=ρ_{D}+ρ_{M} (2)

where ρ_{D} represents redundancy due to the non-uniform distribution of the parameter, and where ρ_{M} represents redundancy due to the parameter correlation in consecutive frames.

Parameters that may be exploited for correlation purposes may include, but are not limited to, speech coding parameters and packet header parameters, as are described in further detail in subsequent sections. Parameter correlation utilizes redundancy in the encoded speech signal and the packet headers. It should be appreciated, however, that the concept of parameter correlation is generally applicable to any multi-bit source parameter. The correlations may be between two or more parameters and may be between parameters of a current frame, or between one or more parameters of a current frame and one or more parameters of a past or future frame. Since parameter correlation may implemented on the decoder side in embodiments, interoperability with other LTE equipment (e.g., encoders and related circuitry) will not be affected.

Furthermore, parameter domain correlation significantly out-performs bit domain correlation in JSCD. As an illustrative reference, consider an exemplary parameter index with a value of 256 which in binary is ‘100000000’. If the next index in time (e.g., in the next transmission frame) is 257 (binary ‘100000001’), there is a high degree of correlation in the bit domain. However, if the next parameter index is 255 (binary ‘011111111’), there is a very low degree of correlation in the bit domain, even though the parameter value varied only slightly from one frame to the next. It should be noted that this lack of correlation becomes more pronounced from MSBs to LSBs. However, if correlation in the parameter domain is used, the shortcomings of bit domain correlation are alleviated and/or overcome as, for example, values of 255, 256, and 257 have a strong correlation when viewed as parameters instead of individual bits.

Parameter domain correlation and probabilities are now described in further detail.

Correlation in the parameter domain may be described in terms of probabilities and log likelihood ratios (LLRs) (e.g., “soft bits”), as noted above. For example, as referenced herein, the vector term x₀={x₀(0), x₀(1)}, . . . , x₀(M−1) is the M-bit coded representation of a parameter with x₀(m)ε{0,1}, m=0, 1, . . . , M−1. Hence, there are 2^{M} such vectors with x₀ⁱ being the i^{th} vector. The complete received vector of indices for the last frame is denoted by Ŷ₋₁, and all bit locations except the m^{th} bit in x₀ is denoted by x₀\m. To find the probability that the transmitted vector was 4, the past history of received indices is used (e.g., one or more previous frames may be used) along with all bit locations within x₀ except the bit for which the bit probability is currently determining, hence x₀\m. Assuming only the previous frame is used for illustrative simplicity, the probability that the transmitted vector (i.e., parameter representation) was x₀ⁱ considering the m^{th} bit is given by:

$${P}_{m} ( {\underline{x}}_{0}^{i} \vert {\underline{\hat{Y}}}_{- 1} , {\underline{x}}_{0} \backslash m ) = \frac{P ( {\underline{x}}_{0}^{i} \vert {\underline{\hat{Y}}}_{- 1} ) \cdot {P}_{m} ( {\underline{x}}_{0}^{i} \vert {\underline{x}}_{0} \backslash m )}{{\sum }_{j = 0}^{{2}^{M} - 1} {P}_{m} ( {\underline{x}}_{0}^{j} \vert {\underline{\hat{Y}}}_{- 1} ) \cdot {P}_{m} ( {\underline{x}}_{0}^{j} \vert {\underline{x}}_{0} \backslash m )} . \qquad ( 3 )$$

The probability shown by Equation 3 is computed for each possible value of the vector (i.e., the parameter representation) for each bit m of the M bits in the vector. For a given parameter having M bits, Equation 3 is performed 2^{M}×M times to determine the probability of each possible vector value when considering each bit in the vector. Once the probability of each index x₀ⁱ is computed, the probability for the m^{th} bit is then simply the sum of the probabilities of each index x₀ⁱ for which the m^{th} bit is equal to x₀ (m):

Pₚ(x₀(m)|Ŷ₋₁,x₀)=Σ_{{i|x}_{₀}₍ₘ₎₌ₓ_{₀}_{ⁱ}₍m)}Pₘ(x₀ⁱ|Ŷ₋₁,x₀\m), (4)

as described in further detail in an exemplary embodiment below in this Section.

In embodiments, information received not only in the previous frame, Ŷ₋₁, but also in even older frames, future frames, and the current frame, may also be exploited. This is denoted simply by Ŷ. The a-priori probability density function (PDF), P(x₀ⁱ|Ŷ), may be assumed, in one approach, as a Markov-0 model. This may be appropriate if there is no correlation between the parameter of interest and any current or previously received parameters. The a-priori PDF may also be used to weight and/or offset probabilities associated with data in the current frame, as shown in Equation 3 above. In this case,

P(x₀ⁱ|Ŷ)==P(x₀ⁱ). (5)

The PDF, P(x₀ⁱ), is obtained by training over a large speech database to determine the probability of occurrence of each index. Such a PDF may be referred to as a reference PDF or reference data. Often, a parameter may have a different distribution (PDF) depending on the speech type, e.g., voiced or non-voiced speech. In these cases, a different PDF for each speech classification type may be used.

In embodiments, a conditional PDF may be used based on parameters received in previous frames. A parameter index that was decoded in a previous frame may be represented by z₋^{j} and may be the same or a different parameter than x. If J total parameters are used, then

$$\begin{matrix}P ( {\underline{x}}_{0}^{i} \vert \underline{\hat{Y}} ) = P ( {\underline{x}}_{0}^{i} \vert {\underline{\hat{Y}}}_{- 1} ) \\ = P ( {\underline{x}}_{0}^{i} \vert {\underline{z}}^{\underline{1}} , {\underline{z}}^{\underline{2}} , … , {\underline{z}}^{\underline{J}} ) \\ = {\sum }_{n 1 = 0}^{N 1 - 1} {\sum }_{n 2 = 0}^{N 2 - 1} … {\sum }_{nJ = 0}^{NJ - 1} P ( \begin{matrix}{\underline{x}}_{0} = i \vert {\underline{z}}^{\underline{1}} = \overline{n 1} , \\ {\underline{z}}^{\underline{2}} = \underline{n 2} … , {\underline{z}}^{\underline{J}} = \underline{nJ}\end{matrix} ) \cdot \\ P ( {\underline{z}}^{\underline{1}} = \underline{n 1} , {\underline{z}}^{\underline{2}} = \underline{n 2} … , {\underline{z}}^{\underline{J}} = \underline{nJ} ) .\end{matrix} \qquad ( 6 )$$

If the solution is constrained to use only the previous frame(s) parameters when those frames were correctly decoded, then the value of the z⁻^{j}'s are known, and Equation 6 may be simplified to:

P(x₀ⁱ|\hat{Y})=P(x₀=i|z₋¹=n1,z⁻²=n2 . . . ,z₋^{j}=nJ). (7)

The above can be easily extended to include parameters in the current frame. However, in that case, simplification (as in Equation 7) may not be possible because the current frame is still being decoded, and it is not yet known if errors exist.

The above approaches can also be extended to include parameters in future frames. For example, if a future frame has already been decoded successfully, the formulation could again be simplified in those cases.

Referring again to FIG. 3, parameter correlation is utilized in first PRAB 306 and in second PRAB 308 to generate conditional probabilities, according to embodiments. As described above, first PRAB 306 receives as an input “soft bits” (e.g., LLRs or “soft decisions”) that are generated by first MAP decoder 302. Any extrinsic information from second PRAB 308 is removed before being input into first PRAB 306. First PRAB 306 then provides its generated extrinsic information as an input to second MAP decoder 304. Second MAP decoder 304 provides its generated “soft bits” to second PRAB 308 as an input, and any extrinsic information from first PRAB 306 is removed before being input into second PRAB 308. Second PRAB 308 then provides its generated extrinsic information as an input to first MAP decoder 302. The process continues until a specified number of iterations have been reached or a solution has been converged upon.

In embodiments where a value xₖ represents a data bit, and where y′ represents one or more received data bits and corresponding parity bits, the “soft bits” (LLRs) generated by first MAP decoder 302 may be represented by Lₘₐₚ^{d1s2}(xₖ), and the “soft bits” (LLRs) generated by second MAP decoder 304 may be represented by Lₘₐₚ^{d2s1}(xₖ). The extrinsic information computed by first PRAB 306 may be represented by Lₑ^{s1}(xₖ), and the extrinsic information computed by second PRAB 308 may be represented by Lₑ^{s2}(xₖ). Thus, the “soft bits” (LLR information) input to first PRAB 306 may be shown as:

Lₘₐₚ^{d1}(xₖ)=Lₘₐₚ^{d1s2}(xₖ)−Lₑ^{s2}(xₖ) (8)

and the “soft bits” (LLR information) input into second PRAB 308 may be shown as:

Lₘₐₚ^{d2}(xₖ)=Lₘₐₚ^{d2s1}(xₖ)−Lₑ^{s1}(xₖ). (9)

This “soft bit” LLR information is used by the first and second PRABs 306/308 along with the a-priori knowledge to derive the prediction probabilities Pₚ (as described above in this section) from which the predicted log likelihood ratios are computed:

$${L}_{e}^{si} ( {x}_{k} ) = log [ \frac{{P}_{p} ( {x}_{k} = 1 \vert {y}^{′} )}{{P}_{p} ( {x}_{k} = 0 \vert {y}^{′} )} ] i = 1 , 2 , \qquad ( 10 )$$

where Pₚ is a probability that may be obtained by incorporating intra-frame and/or inter-frame a-priori knowledge.

An example of parameter domain correlation is now described with reference to FIG. 3 and Equation 3. First PRAB 306 may receive “soft bit” LLR information from turbo decoder 352 (e.g., from first MAP decoder 302). The “soft bit” LLR information includes the “soft” decisions of turbo decoder 352, i.e., LLRs or the likelihood that each bit in a received data packet is a ‘1’ or a ‘0’. Certain values of the bit likelihoods may correspond to one or more parameters associated with the data packet. For instance, an exemplary parameter having 3 data bits may correspond to three consecutive “soft bits” in the LLR domain (i.e., LLRs or LLR information). The “soft bit” LLR information indicates whether turbo decoder 352 has determined the given 3 data bits are likely to be ones (‘1’) or zeroes (‘0’). In the instant example, consider the “soft bit” LLR information from turbo decoder 352 to comprise the values {−2.509, +11.301, −0.988} indicating a likelihood that the 3-bit vector value is ‘010’.

For a given parameter having M bits, Equation 3 is performed 2¹¹/x M times (in the instant example, 2^{M}×M=2³×3=8×3=24 times), where 2^{M} is the number of parameter values possible (e.g., 8 possible bit combinations for a 3-bit value). That is, when considering bit m=0 (e.g., the LSB), the probability of vectors ‘000’, ‘001’, ‘010’, ‘011’ . . . ‘111’ are each computed as described above in Equation 3. Similarly, the parameter-based probability of vectors ‘000’, ‘001’, ‘010’, ‘011’ . . . ‘111’ are each determined when considering bits m=1 and m=2 of the vector. This approach yields probabilities for each bit in the parameter using a parameter-based correlation. In a 3-bit vector with 8 possible values, the possible vector values include 4 instances of ‘0’ and 4 instances of ‘1’ for each bit m as shown in the following table (Table 1).

TABLE 1
Table 1: Exemplary 3-Bit Parameter

| | m = 2 | m = 1 | m = 0 | Pₘ₌₂ | Pₘ₌₁ | Pₘ₌₀ |
|---|---|---|---|---|---|---|
| x₀¹ | 0 | 0 | 0 | 0.05 | 0.1 | 0.2 |
| x₀² | 0 | 0 | 1 | 0.2 | 0.05 | 0.1 |
| x₀³ | 0 | 1 | 0 | 0.35 | 0.2 | 0.3 |
| x₀⁴ | 0 | 1 | 1 | 0.05 | 0.2 | 0.05 |
| x₀⁵ | 1 | 0 | 0 | 0.05 | 0.1 | 0.1 |
| x₀⁶ | 1 | 0 | 1 | 0.1 | 0.2 | 0.05 |
| x₀⁷ | 1 | 1 | 0 | 0.1 | 0.1 | 0.1 |
| x₀⁸ | 1 | 1 | 1 | 0.1 | 0.05 | 0.05 |

As shown in Table 2, Pₘ₌₀ is the probability that the example parameter is x₀ⁱ when considering bit m=0, Pₘ₋ⱼ is the probability that the example parameter is x₀ⁱ when considering bit m=1, and Pₘ₋₂ is the probability that the example parameter is x₀ⁱ when considering bit m=2.

The resulting probabilities from Equation 3 for a given vector representation of a parameter, considering each bit in turn, may be combined to give an overall probability that each bit in the parameter is a ‘1’ or a ‘0’ as provided in the “soft bits” from turbo decoder 352. For instance, consider the example parameter above and the example “soft bit” LLR information {−2.509, +11.301, −0.988} from turbo decoder 352 (indicating a likelihood that the 3-bit vector value is ‘010’). Referencing Table 1, the probabilities from column Pₘ₌₀ for each instance where the vector value is ‘0’ for bit m=0 are added to determine the overall probability that the parameter value is ‘0’ for bit m=0. Hence, the values for m=0 of rows x₀¹, x₀³, x₀⁵, and x₀⁷ are added: 0.2+0.3+0.1+0.1=0.7. In this example, the probability for bit m=0 that the parameter bit value is ‘0’ is 0.7, and the probability of a ‘1’ is 0.3. The probabilities from column Pₘ₌₁ for each instance where the vector value is ‘1’ for bit m=1 are added to determine the overall probability that the parameter value is ‘1’ for bit m=1. Hence, the values for m=1 of rows x₀³, x₀⁴, x₀⁷, and x₀^{B} are added: 0.2+0.2+0.1+0.05=0.55. In this example, the probability for bit m=1 that the parameter value is ‘1’ is 0.55, and the probability of a ‘0’ is 0.45. The probabilities from column Pₘ₌₂ for each instance where the vector value is ‘0’ for bit m=2 are added to determine the overall probability that the parameter bit value is ‘0’ for bit m=2. Hence, the values for m=2 of rows x₀¹, x₀², x₀³, and x₀⁴ are added: 0.05+0.2+0.35+0.05=0.65. In this example, the probability for bit m=2 that the parameter bit value is ‘0’ is 0.65, and the probability of a ‘1’ is 0.35.

Given that the example “soft bit” LLR information from turbo decoder 352 indicated a parameter value of ‘010’, the exemplary overall probabilities determined by first PRAB 306 in this case agree with the “soft” decision of turbo decoder 352 (e.g., from first MAP decoder 306). The exemplary overall probabilities are used to compute “soft bits” or LLR information (as shown in Equation 10 above) that are provided from first PRAB 306 to turbo decoder 352 (e.g., to second MAP decoder 304). For example, the three “soft bits” of the LLR information computed by first PRAB 306 are determined as:

$$L ( {x}_{k} ) = log [ \frac{0.3}{0.7} ] for bit parameter bit m = 0 , \\ L ( {x}_{k} ) = log [ \frac{0.55}{0.45} ] for bit parameter bit m = 1 , and$$

$$L ( {x}_{k} ) = log [ \frac{0.35}{0.65} ] for bit parameter bit m = 2.$$

Second MAP decoder 304 may use this input to compute its own “soft bits” (LLRs) which may in turn be provided by turbo decoder 352 to second PRAB 308, and the exemplary process described above may be repeated by then using second PRAB 308 to provide “soft bits” (LLRs) to first PRAB 306, and so on.

It should be noted that while a 3-bit parameter is described in the example above, different sized parameters are contemplated, and that the “soft bits” (LLRs) provided and received by the elements of FIG. 3 described in the example above may include “soft bit” likelihood representations of each bit in a data packet, but only a 3-bit parameter is described for the sake brevity and clarity of illustration.

The next section describes JSCD embodiments, with respect to JSCD block 300 as described above, in which parameter domain correlation of speech information is utilized to improve channel decoding.

### 6. Example Joint Source Channel Decoding Embodiments that Exploit Speech Coding Parameter Correlation

An A-priori Speech Statistics Algorithm (ASSA) is now described that uses a-priori speech information to facilitate joint source channel decoding (JSCD). In particular, the correlation of certain source-encoded speech parameters is used to facilitate joint source channel decoding. For the AMR-NB (Adaptive Multi-Rate Narrowband) speech codec used in VoLTE (Voice over LTE), the parameters that may be focused on include, but are not limited to, pitch, Line Spectral Pairs (LSPs), pitch gain, and fixed codebook gain. Models (e.g., conditional probability density functions (PDFs)) are obtained for each of the parameters and are applied to update the soft bit values that are obtained for each parameter during channel decoding (turbo decoding in VoLTE). The models applied may vary depending upon whether the speech is classified as voiced or unvoiced. For example, in the case of an AMR-NB speech codec operating at 12.2 Kb/s, voiced speech may include up to 23 bits, or more, of total signal redundancy, and unvoiced speech may include up to 16 bits, or more, of total signal redundancy.

Speech redundancy may be utilized with the parameter-based probability equations noted in the previous section (e.g., Equations 3, 6, and 7). To apply parameter based probability, one or more a-priori probability density functions (PDFs) are generated based on known speech data. For example, the probability of a given vector (e.g., parameter) based on a given frame (e.g., a previous frame) may be shown as:

P(x₀ⁱ|Ŷ₋₁) or more generally, P(x₀ⁱ|Ŷ), (11)

as noted above. Generated a-priori PDFs may be stored in a memory for use in decoding. As described in this section, the ASSA may be implemented as a further embodiment of first ASSA block 330 and/or second ASSA block 334, as discussed above and shown in FIG. 3. In embodiments, ASSA may be utilized with any given speech coding parameter, such as, but not limited to, pitch, line spectral pairs (LSPs), pitch gain, fixed codebook gain, and/or the like.

Pitch and pitch period are now described in detail. The pitch distribution for voiced and unvoiced speech is significantly different. To better exploit the pitch redundancy, a voiced/unvoiced classifier is employed at the joint source channel decoder (e.g., in first and/or second ASSA blocks 330/334), and separate PDFs are used for each classification.

The correlation of pitch parameters may be performed with respect to the pitch in sub-frames of a given frame. For instance, in the 12.2 Kb/s AMR-NB speech codec example described above, the pitch in the first and third sub-frames is quantized with a 9-bit scalar quantizer. For voiced speech, the pitch is highly correlated in time. To exploit this, the pitch for the current sub-frame is predicted based on the pitch history. The probability density function (PDF) of the difference between the index of the quantized predicted pitch and the index of the actual pitch is obtained over a large database offline. Then during online processing, the PDF is centered about the index of the quantized predicted pitch to obtain the term P(x₀ⁱ|Ŷ₋₁).

An encoder may select a pitch at double or half the actual pitch. This results in a “spreading” of the PDF. During offline processing for computation of the PDF, the estimated pitch is doubled and halved and compared to the true pitch. If it is within a given tolerance, the estimated pitch is altered accordingly (double or halved) before computation of the difference, and PDFs for pitch doubling and for pitch halving are obtained. Then, during processing, a composite PDF is obtained using the difference PDF centered at the predicted pitch index, a second difference PDF centered at the pitch double location and weighted by the probability of a pitch double (obtained from the pitch double PDF), and a third difference PDF centered at the pitch half location and weighted by the probability of a pitch half (again, obtained from the pitch half PDF). In other words, the composite PDF shows a high probability of the true pitch, and lesser probabilities of the half pitch and the double pitch.

The pitch in the second and fourth sub-frames is differentially quantized using a 6-bit scalar quantizer. The difference between the current sub-frame and the previous sub-frame is used. Because the temporal correlation is removed in the 6-bit quantization, the ASSA simply uses a PDF of the quantized codebook indices. LSPs are next described in detail. Generally speaking, LSPs provide a representation of the spectrum of speech on a frame by frame basis. LSPs are derived from the linear prediction coefficients (LPCs). LSPs are used in place of LPCs because they have better quantization properties. In embodiments, two sets of LSP coefficients per frame are quantized (e.g., in the second and fourth sub-frames). The prediction residual following a fixed, first-order moving average predictor (using error vector inputs) is a split matrix quantized using 2×2 matrices with 7, 8, 9, 8, and 6-bit codebooks. Though the quantization uses prediction, there is still significant correlation remaining in the prediction residual after the first-order moving average prediction. To exploit this redundancy, a pair of LSP vectors are first predicted based on a history of decoded LSPs. This predicted pair of LSPs is then quantized using the fixed, first-order moving average split matrix scheme. The PDF of the difference between this predicted index and the actual index is obtained through observation over a large database. It should be noted that if there are too many error frames in the history buffer, the predicted LSP vectors may be unreliable. In this case, the PDF of the codebook indices is used directly. Using the PDF of the codebook indices does not exploit the temporal redundancy remaining in the indices after moving average prediction, but provides better performance in high packet loss rate conditions. In either case, separate PDFs are used for voiced and unvoiced speech.

Pitch gain is next described in detail. In AMR-NB at 12.2 kb/s, the pitch gain is scalar value quantized every sub-frame with 4 bits. For the pitch gain in the first 3 sub-frames of a given frame, the PDF of the pitch gain in the current sub-frame is conditioned on the pitch gain in the prior sub-frame, x₋₁, and in the next sub-frame, x₁:

P(x₀ⁱ|\hat{Y})=Σₙ₁₌₀^{N-1}Σₙ₂₌₀^{N-1}P(x₀=i|x₋₁=n1,x₁=n2)·P(x₋₁=n1,x₁=n2), (12)

where ‘N’ is the number of bits used for quantization (e.g., 4). To simplify computation of the weighting term, independence may be assumed. Hence,

P(x₋₁=n1,x₁=n2)≅P(x₋₁=n1)·P(x₁=n2). (13)

Each term is then obtained using the “soft bits” (LLRs), Lₘₐₚ^{d}(xₖ), and multiplying the individual bit probabilities to obtain the index probabilities:

P(x₋₁=n1)=Σₘ₌₀³P(xₖ(m+Offset1)=n1(m)) (14)

and

P(x₁=n2)=Σₘ₌₀³P(xₖ(m+Offset2)=n2(m)) (15)

with Offset1 and Offset2 pointing to where x₋₁ and x₁ reside in the likelihood vector Lₘₐₚ^{d}(xₖ).

For the fourth (last) sub-frame in the given frame, the pitch gain in the next sub-frame is not available since it resides in the next frame. In this case, only the PDF of the pitch gain in the prior sub-frame, x₋₁ is used. Separate PDFs are used for voiced and unvoiced speech.

Fixed codebook gain is next described in detail. For fixed codebook gain, the residual after fourth-order moving average prediction is scalar quantized using 5 bits. Due to the extensive prediction, there is only a small amount of temporal redundancy remaining. In the first sub-frame, the conditional PDF with the fixed codebook gain in the last sub-frame of the previous frame is used. Such an approach is used when the last frame is decoded error free, and hence, the index of the prior sub-frame gain is known. In this case,

$$P ( {\underline{x}}_{0}^{i} \vert \underline{\hat{Y}} ) = {\sum }_{n 1 = 0}^{N - 1} P ( {\underline{x}}_{0} = i \vert {\underline{x}}_{- 1} = \underline{n 1} ) \cdot P ( {\underline{x}}_{- 1} = \underline{n 1} ) = P ( {\underline{x}}_{0} = i \vert {\underline{x}}_{- 1} ) . \qquad ( 16 )$$

If the last frame contains errors, a simple Markov-0 model is used that utilizes the distribution of the codebook indices themselves:

P(x₀ⁱ|Ŷ)=P(x₀=i) (17)

This is also applicable for the second, third, and fourth sub-frame fixed codebook gains. In all cases separate PDFs are used for voiced and unvoiced speech.

The next section describes JSCD embodiments, with respect to JSCD block 300 as described above, in which parameter domain correlation of packet headers is utilized to improve channel decoding.

### 7. Example Joint Source Channel Decoding Embodiments that Exploit Packet Field Redundancy

A Packet Header Statistics Algorithm (PHSA) is described that uses a priori knowledge of a protocol stack (e.g., the LTE protocol stack) to facilitate joint source channel decoding. Models of each protocol layer are developed which predict the values of the headers in future frames. In particular, models (e.g., probability density functions (PDFs)) are obtained for certain header elements and are applied to update the soft bit values that are obtained for each element as part of a joint source channel decoding process. Because of the significant redundancy introduced in the headers by the protocol stack, the PHSA used in conjunction with a joint source channel turbo decoder provides significant improvement in decoding performance. It should be noted that while the PHSA is described in terms of “packet headers” and “packet header redundancy,” other packet fields may be utilized with the PHSA embodiments described herein. As such, the term “packet field redundancy” may be used interchangeably with “packet header redundancy.” It should also be noted that at lower operating rates, the percentage of signal redundancy with respect to packet headers increases, thus offering even greater benefits.

Packet header redundancy may be utilized with the parameter-based probability equations noted in the sections above (e.g., Equations 3, 6, and 7). To apply parameter based probability, one or more a-priori probability density functions (PDFs) are generated based on known and/or previous header information. For example, the probability of a given vector (e.g., header field) based on a given frame (e.g., a previous frame) may be shown using Equation 11:

P(x₀ⁱ|Ŷ₋₁) or more generally, P(x₀ⁱ|Ŷ), (11)

as noted above. Generated a-priori PDFs may be stored in a memory for use in decoding. As described in this section, the PHSA may be implemented as a further embodiment of first PHSA block 332 and/or second PHSA block 336, as discussed above and shown in FIG. 3. In embodiments, the PHSA may be utilized with any packet header parameters, such as headers associated with, but not limited to, a MAC layer, an RLC layer, a PDCP layer, and an RoHC layer, as well as an RTP payload, transport block padding, and/or the like. Examples of redundancy in these parameters are discussed below.

In each parameter described in this section, reserve bits with set values of ‘1’ or ‘0’ may be present. Reserve bits increase parameter correlation and allow for the PHSA to further improve decoding. In parameters with reserved bits, the probability of reserve bit with a value of ‘1’ may be shown as:

P(x₀(k)=1|Ŷ₋₁)=1.0−ε, (18)

and the probability of reserve bit with a value of ‘0’ may be shown as:

P(x₀(k)=0|Ŷ)=1.0−ε, (19)

where ε is a very small number such that 1.0−ε is approximately equal to 1, and where k is a given bit in the parameter vector. Similarly, non-reserved bits or padding bits in the described parameters that are set to ‘1’ or ‘0’ according to various protocols also increase parameter correlation and allow for the PHSA to further improve decoding. Probabilities for these bits may also be shown according to Equations 18 and 19. The values of the reserved bits may be verified by checking blocks that are correctly decoded in PHY layer 202 (e.g., by turbo decoder 214) to make sure that the previously reserved bits remain reserved. That is, in the event a reserved bit or field is used for other purposes (i.e., it is no longer reserved), the embodiments described herein may determine that if a correctly decoded block does not adhere to the previous reserved bit setting, “soft bits” for locations relating to previously reserved bits that are no longer reserved are not modified. This determination may be made, for example, on a call-by-call basis.

The MAC header resides in the most significant bits of the data packet. For fixed sized data packets, the MAC header is a single byte. The two most significant bits (MSBs) are reserved (‘0’), and thus their probabilities are calculated according to Equation 19 above. An Extension Field occupies the next bit and is set to ‘0’ for voice packets, therefore this bit's probability is also calculated according to Equation 19. The Logical Channel ID (LCID) occupies the remaining five least significant bits (LSBs), the most significant of which is set to ‘0’ and thus also has a probability calculated according to Equation 19. The LCID may range in value between 0x00001-0-01010, and once set, is static for the duration of a voice call. As such, observation of the first few correctly received packets will yield the LCID field value for the remainder of the call which increases correlation for this parameter.

The RLC header includes a two-bit segmentation indication field (FI) that is set to ‘00’ for voice calls, and the probability for this field is calculated according to Equation 19. An Extension Field occupies the next bit and is set to ‘0’ for voice packets, therefore this bit's probability is also calculated according to Equation 19. The RLC header also includes a five-bit sequence number. The sequence number increments by one in each subsequent packet. The starting value of the sequence number can be obtained by observing the sequence number in the first correctly received packet while setting the corresponding bit probabilities to 0.5. After obtaining the sequence number, the sequence number for the next packet is predicted by incrementing the value by 1. Because of the possibility of duplicate and out-of-sequence packets, the LSBs of the sequence number are less predictable than the MSBs. The probabilities can be obtained based on the past history of received packets. A “forgetting factor” is used to ensure that the statistics adapt to changing network behavior.

In some embodiments, the probability of a packet arriving out of sequence by ‘n’ packets (where n=−N₁+1, −N₁+2, . . . , 0, 1, 2, . . . , N₂) is determined by observing the past history of received packets which were correctly decoded. This can be done in a number of ways. For example, a sliding window of length ‘M’ packets can be used. The number of times a packet arrives out of sequence by n is maintained. If nᵢ is the number observed in the last M packets for when n=i′, then the probability that the packet is out of sequence by i packets is given by nᵢ/M (nᵢ divided by M). In some embodiments, a running average approach can be used with a forgetting factor α. The probability of each n is initialized to an estimate, which may be predefined or determined on a case-by-case basis. If it is observed that the last packet arrived out of sequence by T packets, then if the probability estimate of n=i at time ‘t’ is denoted P(n=i)ₜ, the probabilities are updated by:

P(n=j)ₜ₊₁=[P(n=j)ₜ×α]+[1−α] (20)

and

P(n=j)ₜ₊₁=P(n=j)ₜ×α, for i≠j (21)

In either method, the value of M or α can be determined or adjusted based on the expected network conditions. It is contemplated that other methods can be used to estimate the probabilities and will be equally applicable to the embodiments and techniques described herein.

Next, the PDF for each possible sequence number is obtained. If the last sequence number SN(t)=sn, and the sequence number is of length ‘B’ bits, then:

P(SN(t+1)=(sn+1+v)%B)=P(n=v)ₜ₊₁, (22)

where ‘v’ is the number of packets by which sn is out of order and where ‘%’ denotes the modulus operator. Once the PDF is built according to Equation 22, the determination of probabilities described above with respect to Equations 3 and 4 may be used. Generally speaking, the approach described with respect to Equations 20, 21, and 22 can be extended to monitoring received bits, estimating their probabilities, and then applying this a-priori knowledge to improve channel decoding.

The PDCP header includes a one-bit Data/Control Field as the MSB which is set to ‘1’ (data) in a voice packet. Hence, the probability for this bit is calculated according to Equation 18. The PDCP header also includes a seven-bit sequence number. The sequence number increments by one in each subsequent packet. The starting value of the sequence number can be obtained by observing the sequence number in the first correctly received packet while setting the corresponding bit probabilities to 0.5. After obtaining the sequence number, the sequence number for the next packet is predicted by incrementing the value by 1. Because of the possibility of duplicate and out-of-sequence packets, the LSBs of the sequence number are less predictable than the MSBs. The probabilities can be obtained based on the past history of received packets. A “forgetting factor” is used to ensure that the statistics adapt to changing network behavior.

The RoHC portion of the data packet may be of variable length. The length of the transport block is used to determine the length of the RoHC header and subsequent position of the remaining headers and payload in the transport block, assuming that the other headers and the payload have not changed in size. In cases where either other headers or the payload have changed in size, if the possible change in size of the other headers or the payload is known, the structure of the transport block can be deduced with high certainty.

The RTP payload may be packed in either Bandwidth-Efficient Mode or an Octet-Aligned Mode according to Request for Comments 4867 titled “RTP Payload Format and File Storage Format for the Adaptive Multi-Rate (AMR) and Adaptive Multi-Rate Wideband (AMR-WB) Audio Codecs” (April 2007) (hereinafter “RFC 4867”). However, IR.92 recommends that the Bandwidth-Efficient Mode be requested by default, and this embodiment is described below although it should be noted that the principles described herein may be implemented according to either mode.

A four-bit codec mode request (CMR) field occupies the four MSBs. According to RFC 4867, if a terminal continuously desires to receive frames in the same mode ‘X’, the terminal sets CMR=‘X’ for all its outbound payloads, and if a terminal has no preference in which mode to receive, the terminal should set CMR=‘15’ in all its outbound payloads. Changes in CMR values are infrequent. In one embodiment, the prior CMR value is used to predict the current CMR value. In cases where the CMR changes, the turbo decoder in the PHY (e.g., first turbo decoder 214 in PHY layer 202) will be relied upon to properly decode such a packet and convey any requests for codec mode. This approach has the advantage of using very large probabilities (1.0−ε) for the CMR bit values which improve decoding performance. This is at the cost of not being able to decode the packet correctly if CMR changes. Because a change in CMR is unpredictable, the probabilities would have to be reduced substantially to correctly decode a packet with a change in CMR, but this would dramatically reduce the improvement obtained from the correct CMR prediction for the vast majority of the frames. To help alleviate this concern, a tradeoff may be made in which the possible values of the CMR field can be reduced by considering the negotiated codec mode set that is determined during call setup, as specified in IR.92. Thus, in one embodiment, probabilities may be increased (although not to the level of 1.0-e) while still allowing for properly decoded packets.

A six-bit table of contents (ToC) field occupies the next six MSBs of the RTP payload. The ToC consists of a list of entries, each representing a speech frame. In order to accurately predict the ToC field, the number of frames per packet (fpp) in the current packet must be known. The fpp can in general be deduced from the transport block size, taking into account the number of bits in each codec mode, and the size of the other headers, especially the RoHC header which has a variable size. In addition, though the codec mode may change during a call, the fpp is very unlikely to change. Still further, IR.92 recommends 1 fpp for VoLTE, so the vast majority of calls are expected to use only 1 fpp.

The first ToC field is a 1-bit “F” field that indicates if the frame is followed by another speech frame in this payload or not. If set to ‘1’, another speech frame follows the current frame. If set to ‘0’, this is the last frame in this payload. As a result, the F field can be predicted accurately if the fpp is known. The next ToC field is a 4-bit frame type (FT) field that indicates the AMR speech coder mode or the use of comfort noise (SID). In the case of 1 fpp, the frame type possibilities can be determined from Table 2.

TABLE 2
VoLTE Transport Block Breakdown

| AMR | | | | | | |
|---|---|---|---|---|---|---|
| Mode | AMR Size | VoIP Frame | PDU1 | PDU2 | PDU3 | TBS |
| 12.2 kb/s | 244 | 256 | 304 | 312 | 320 | 328 |
| 10.2 kb/s | 204 | 216 | 264 | 272 | 280 | 296 |
| 7.95 kb/s | 159 | 176 | 224 | 232 | 240 | 256 |
| 7.4 kb/s | 148 | 160 | 208 | 216 | 224 | 224 |
| 6.7 kb/s | 134 | 144 | 192 | 200 | 208 | 208 |
| 5.9 kb/s | 118 | 128 | 176 | 184 | 192 | 208 |
| 5.15 kb/s | 103 | 120 | 168 | 176 | 184 | 208 |
| 4.75 kb/s | 95 | 112 | 160 | 168 | 176 | 176 |
| SID | 40 | 56 | — | — | 120 | 144 |

In the case where multiple frame types use the same transport block size, the negotiated allowable codec mode set may be used to identify the correct rate. In the unlikely case where the allowable codec mode set includes two or more modes with the same transport block size, the previously received mode can be used to predict the current mode. In addition, if a codec mode request has been sent requesting a codec mode change, this knowledge can used to predict that the FT may change to the requested codec mode.

In the case of multiple frames per packet (fpp), a table similar to Table 2 is contemplated for use with an approach similar to the 1 fpp case described above

The next ToC field is a frame quality indicator (Q) that indicates if the corresponding frame is severely damaged (‘0’) or not (‘1’). If the frame was indeed severely damaged in the network and the Q-bit set to 0, it is unlikely that the frame can be correctly decoded even with JSCD. As such, the Q-bit is assumed to be ‘1’ and therefore the probability for this bit is calculated according to Equation 18 above.

Padding in the RTP payload is done according to Section 4.1 of RFC 4867 specifies that the payload length is always made an integral number of octets by padding with zero bits if necessary. The number of padding bits is determined by computing the total number of bits in the RTP payload including the codec and RTP header as described above and factoring in the frames per packet. If the total number of bits is “N”, then the number of padding bits is given by N_{pad}=8−N % 8 where % is the modulus operator. The LSBs are then padded with zeros, and therefore the probability for these bits are calculated according to Equation 19 above.

Transport block padding is described next. The total size of the protocol data unit is given by the following sum: codec+RTP Header+RTP Padding+RoHC Header+PDCP Header+RLC Header+MAC Header. Since the transport block size has only a finite set of possible values, often the protocol data unit must be padded in order to fill the transport block. These padding bits are set to zero. Therefore, after predicting all of the headers, codec type, and fpp, the total number of bits in the protocol data unit can be computed and the number of predicted transport block padding bits is obtained. It follows then that the probability for these bits are calculated according to Equation 19 above.

Additional considerations are contemplated for parameters that correspond to sequence numbers. That is, PRAB elements (e.g., first and second PHSA blocks 332/336) may contain logic and/or decision blocks/modules to improve correlation of sequence numbers such as the “forgetting factor” described in this Section. Additionally, for instance, the exemplary 8-bit parameter index described in Section 5 above may correspond to a sequence number. As noted, when this parameter index has a value of 256 which in binary is ‘100000000’, if the next index in time (e.g., in the next transmission frame) is 257 (binary ‘100000001’), there is a high degree of correlation in the bit domain. However, if the next parameter index is 255 (binary ‘011111111’), there is a very low degree of correlation in the bit domain, even though the parameter value varied only slightly from one frame to the next. However, if correlation in the parameter domain is used, values of 255, 256, and 257 have a strong correlation when viewed as parameters. Thus it is contemplated that instances of sequence number “roll over,” especially concerning the most significant bits in the value, the embodiments described herein account for such possibilities to enable proper parameter domain correlation.

The next section describes general JSCD embodiments in which parameter domain correlation is utilized to perform joint source channel decoding.

### 8. Further Example Embodiments and Advantages for Joint Source Channel Decoding with Parameter Domain Correlation

The embodiments described herein enable the decoding of encoded data using parameter domain correlation. Embodiments provide for parameter correlation using speech coding and packet header redundancies to improve decoding. It is contemplated, however, that the parameter correlation embodiments described may be applicable to decoding strategies and implementations other than those explicitly set forth herein. For example, decoders in addition to turbo decoders may be used to exploit the benefits of parameter-based correlation. Likewise, other parameters (in addition to speech and packet header parameters) may be used to improve channel decoding. For example and without limitation, video coding parameters may be used. Further, protocols other than LTE and VoLTE may also benefit from parameter correlation for channel decoding as described above. Still further, alternative probability determination strategies are also contemplated as being applicable in parameter correlation implementations.

It will be recognized that the systems, their respective components, and/or the techniques described herein may be implemented in hardware, software, firmware, or any combination thereof, and/or may be implemented as hardware logic/electrical circuitry. The disclosed technologies can be put into practice using software, firmware, and/or hardware implementations other than those described herein. Any software, firmware, and hardware implementations suitable for performing the functions described herein can be used, such as those described in the following sections.

### 9. Example Operational Embodiments

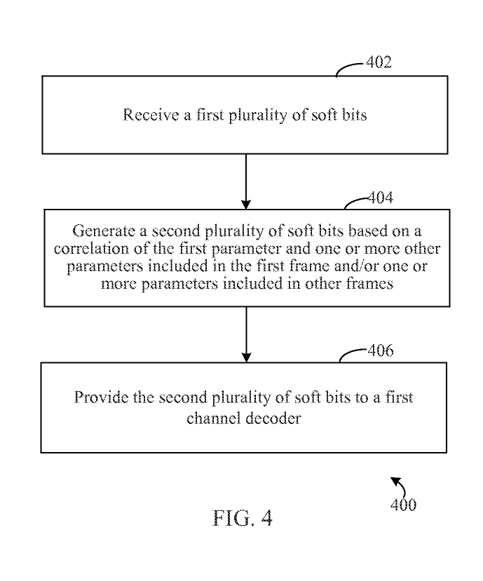

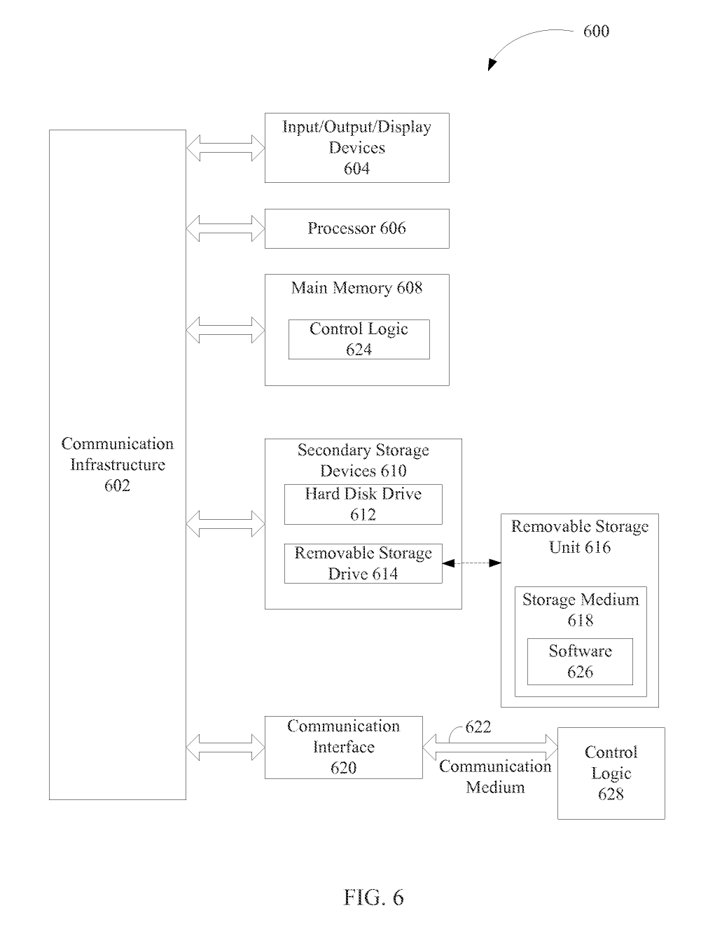

The embodiments described herein may perform their functions in various ways. For example, FIG. 4 shows a flowchart 400 providing example steps for using parameter-based correlation in joint source channel decoding, according to an exemplary embodiment. LTE architecture 200 of FIG. 2, JSCD block 300 of FIG. 3 and computer 600 of FIG. 6 (described below) may each operate according to flowchart 400, in an embodiment. Other structural and operational embodiments will be apparent to persons skilled in the relevant art(s) based on the discussion regarding flowchart 400. Flowchart 400 is described as follows.

Flowchart 400 may begin with step 402. In step 402, a first plurality of “soft bits” may be received. The first plurality of “soft bits” may be representative of a first probability that one or more bits of a first parameter in a first frame are each a zero or a one respectively, and may be received at a PRAB, an ASSA block, and/or a PHSA block. For example, referring again to FIG. 3, first PRAB 306 may receive a first plurality of “soft bits” (e.g., LLRs as described above) from turbo decoder 352 (e.g., from first MAP decoder 302). In some embodiments, the first plurality of “soft bits” may be received by first PRAB 306 via line 354 from turbo decoder 214 (shown in FIG. 2).

In step 404, a second plurality of “soft bits” is generated. The second plurality of “soft bits” (e.g., LLRs) may be may be representative of a second probability that one or more bits of a second parameter in a first frame are each a zero or a one respectively, and may be determined at a PRAB, an ASSA block, and/or a PHSA block. The second plurality of “soft bits” may be generated based upon a correlation of the first parameter and one or more other parameters included in the first frame and/or one or more parameters included in other frames. For example, referring again to FIG. 3, first PRAB 306 may determine a second plurality of “soft bits” using first ASSA block 330 (e.g., for a speech parameter) and/or first PHSA block 332 (for a packet header/field parameter). The second plurality of “soft bits” may be determined, in whole or in part, in accordance with one or more of the Equations described above.

In step 406, the second plurality of “soft bits” is provided to a first channel decoder. For example, first PRAB 306 may provide the determined second plurality of “soft bits” to turbo decoder 352. In embodiments, second MAP decoder 304 may receive the second plurality of “soft bits” from first PRAB 306.

It is also contemplated that, while flowchart 400 is described in terms of receiving the first “soft bit” likelihood at first PRAB 306 from turbo decoder 352 (and first MAP decoder 302) or turbo decoder 214, determining the first plurality of “soft bits” at first PRAB 306, and providing it to turbo decoder 352 (and second MAP decoder 304), in embodiments, flowchart 400 may be performed in terms of receiving the first plurality of “soft bits” at second PRAB 308 from turbo decoder 352 (and second MAP decoder 304) or turbo decoder 214, determining the second plurality of “soft bits” at second PRAB 308, and providing it to turbo decoder 352 (and first MAP decoder 302). Additionally, it is contemplated that several iterations of flowchart 400 may be performed in an exemplary manner as follows (and as described in the sections above): (1) receive the first plurality of “soft bits” at first PRAB 306 from turbo decoder 352 (and first MAP decoder 306), (2) determine the second plurality of “soft bits” at first PRAB 306, (3) provide it to turbo decoder 352 (and second MAP decoder 304), (4) receive an additional plurality of “soft bits” at second PRAB 308 from turbo decoder 352 (and second MAP decoder 304), (5) determine yet another plurality of “soft bits” at second PRAB 308, and (6) provide it to turbo decoder 352 (and first MAP decoder 302). The exemplary iterative manner of performance just described may be repeated as required by design.

In some example embodiments, one or more steps 402, 404, and/or 406 of flowchart 400 may not be performed. Moreover, steps in addition to or in lieu of steps 402, 404, and/or 406 may be performed. Further, in some example embodiments, one or more of steps 402, 404, and/or 406 may be performed out of order, in an alternate sequence, or partially (or completely) concurrently with other steps.

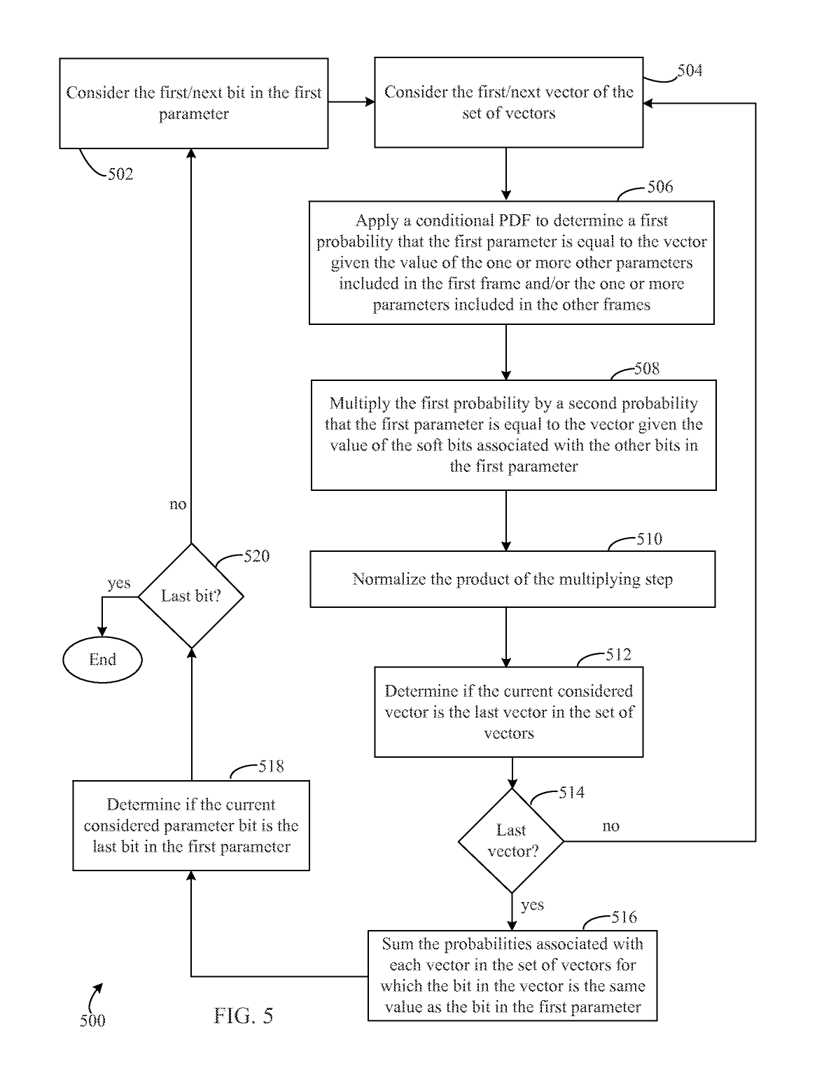

As noted above with respect to FIG. 4, the embodiments described herein may perform their functions in various ways. For example, FIG. 5 shows a flowchart 500 providing example steps for using parameter-based correlation in channel decoding, according to an exemplary embodiment. In some embodiments, flowchart 500 may be a further embodiment of step 404 of flowchart 400, as shown in FIG. 4, and with respect to Equations 3 and 4 described above. LTE architecture 200 of FIG. 2, JSCD block 300 of FIG. 3 and computer 600 of FIG. 6 (described below) may each operate according to flowchart 500, in an embodiment. Other structural and operational embodiments will be apparent to persons skilled in the relevant art(s) based on the discussion regarding flowchart 500. Flowchart 500 is described as follows.

In the described exemplary embodiment that follows, the steps of flowchart 500 may be performed by first PRAB 306, second PRAB 308, and/or any of their respective components/circuits. Further, as describe herein with respect to flowchart 500, a first parameter comprises one of a predefined set of vectors as shown, for instance, above in the example of parameter domain correlation in Section 5.

Flowchart 500 may begin with step 502. In step 502, the first or next bit in the first parameter are considered. Each bit in the parameter may be considered, as will become apparent in the description of flowchart 500. That is, for each bit in the first parameter, the steps that follow may be performed. For example, each bit m of the illustrative M-bit parameter described in the example of parameter domain correlation in Section 5 is considered. Once a bit is considered, the flowchart proceeds to the next step (504).

In step 504, the first or next vector of the set of vectors is considered. Each vector in the set is be considered for each bit considered in step 502, as will become apparent in the description of flowchart 500. That is, for each bit in the first parameter, each vector in the set of vectors is considered. For example, each vector x₀¹ through x₀⁷ described in the example of parameter domain correlation in Section 5 and Table 1 is considered for each bit of the parameter. Once a vector is considered, the flowchart proceeds to the next step (506).

In step 506, a conditional probability density function (PDF) is applied to determine a first probability that the first parameter is equal to the vector given the value of the one or more other parameters included in the first frame and/or the one or more parameters included in the other frames. In embodiments, the term P(x₀ⁱ|Ŷ₋₁) of the numerator of Equation 3 may correspond to the PDF.

In step 508, the first probability is multiplied by a second probability that the first parameter is equal to the vector given the value of the soft bits associated with the other bits in the first parameter. In embodiments, the term Pₘ(x₀ⁱ|x₀\m) of the numerator of Equation 3 may correspond to the second probability.

In step 510, the product of the multiplying step (508) is normalized. This normalization may be performed, for example, using the denominator of Equation 3.

In step 512, it is determined whether the current considered vector is the last vector of the set of vectors. If not, at 514 the flowchart returns to step 504 where the next vector of the set is considered. If the current considered vector is the last vector of the set of vectors, at 514 the flowchart proceeds to step 516.

In step 516, the probabilities associated with each vector in the set of vectors for which the bit in the vector is the same value as the bit in the first parameter are summed Step 516 may be exemplified in embodiments using Equation 4 described above.

At step 518, it is determined if the current considered parameter bit is the last bit in the first parameter. If not, at 520 the flowchart returns to step 502 where the next bit in the first parameter is considered. If the current considered parameter bit is the last bit in the first parameter, from step 520 the flowchart ends.

It is contemplated that, while flowchart 500 may be exemplified by in the example of parameter domain correlation in Section 5, the application of flowchart 500 is not so limited.

In some example embodiments, one or more steps 502, 504, 506, 508, 510, 512, 514, 516, 518, and/or 520 of flowchart 500 may not be performed. Moreover, steps in addition to or in lieu of steps 502, 504, 506, 508, 510, 512, 514, 516, 518, and/or 520 may be performed. Further, in some example embodiments, one or more of steps 502, 504, 506, 508, 510, 512, 514, 516, 518, and/or 520 may be performed out of order, in an alternate sequence, or partially (or completely) concurrently with other steps.

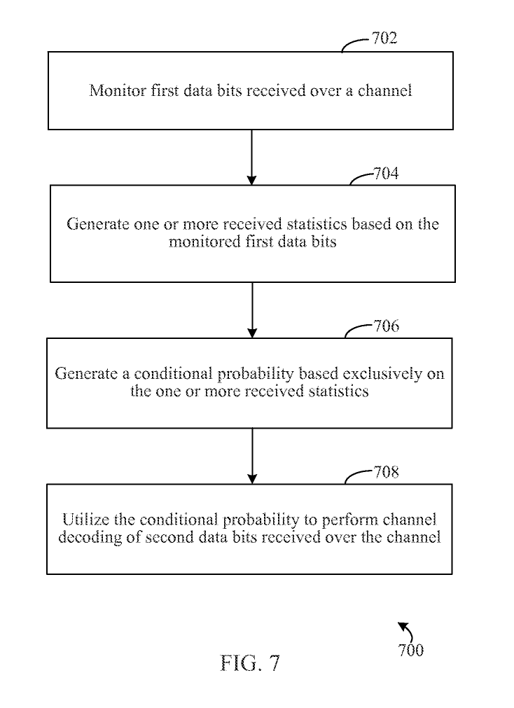

A further example embodiment of performing functions described herein is presented in FIG. 7. For example, FIG. 7 shows a flowchart 700 providing example steps for using parameter-based correlation in joint source channel decoding, according to an exemplary embodiment. LTE architecture 200 of FIG. 2, JSCD block 300 of FIG. 3 and computer 600 of FIG. 6 (described below) may each operate according to flowchart 700, in an embodiment. Other structural and operational embodiments will be apparent to persons skilled in the relevant art(s) based on the discussion regarding flowchart 700. Flowchart 700 is described as follows.

Flowchart 700 may begin with step 702. In step 702, first data bits received over a channel are monitored. The first data bits may be a portion of data bits in a received frame, or a plurality of received frames, and may be monitored by a PRAB, an ASSA block, a PHSA block, and/or other blocks described in the embodiments described herein. For example, referring again to FIG. 3, first PRAB 306 and/or second PRAB 308 may monitor first data bits from turbo decoder 352. Similarly, referring to FIG. 2, PRAB 264 may monitor first data bits from turbo decoder 214.

In step 704, one or more received statistics are generated based on the monitored first data bits. The received statistics may be generated by a PRAB, an ASSA block, a PHSA block, and/or other blocks described in the embodiments described herein. In embodiments, the received statistics may be generated for one or more bits in the monitored first data bits (e.g., the first bit, the second bit, the third bit, etc.). For example, monitored first data bits in a given number of received frames (e.g., the past 100 frames) may be used to determine the number of times a certain bit(s) has been a 1 or a 0. In this example, if a given bit (i.e., a bit at a given position in the first data bits) has been a 1 in 90 of the frames and a 0 in 10 of the frames, the received statistics for a bit value of 1 are 90% and for a bit value of 0 are 10%.

In step 706, a conditional probability is generated based exclusively on the one or more received statistics. The conditional probability may represent the likelihood that the next bit monitored is a 1 or a 0 based on the received statistics, and may be generated by a PRAB, an ASSA block, a PHSA block, and/or other blocks described in the embodiments described herein. Continuing from the previous example, the 90% and 10% statistics may be used to generate, in accordance with one or more of the Equations, embodiments, and/or examples described above, the conditional probability as:

$$log [ \frac{0.9}{0.1} ] .$$

In step 708, the conditional probability is utilized to perform channel decoding of second data bits received over the channel. For example, in the case where a PRAB (e.g., first PRAB 306 and/or second PRAB 308 of FIG. 3) are used to generate the conditional probability, the conditional probability may be provide to a channel decoder (e.g., turbo decoder 352 of FIG. 3) to be utilized in performing channel decoding.

In some example embodiments, one or more steps 702, 704, 706, and/or 708 of flowchart 700 may not be performed. Moreover, steps in addition to or in lieu of steps 702, 704, 706, and/or 708 may be performed. Further, in some example embodiments, one or more of steps 702, 704, 706, and/or 708 may be performed out of order, in an alternate sequence, or partially (or completely) concurrently with other steps.

### 10. Example Computer Embodiments

JSCD block 216, turbo decoder 262, PRAB(s) 264, AMR 218, jitter buffer 256, decompression block 252, decryption block 244, cypher stream block 248, reordering and duplication detection block 240, turbo decoder 214, HARQ block 230, demodulator block 226, JSCD block 300, turbo decoder 352, first MAP decoder 302, second MAP decoder 304, first PRAB 306, first ASSA block 330, first PHSA block 332, second PRAB 308, second ASSA block 334, second PHSA block 336, interleaver blocks 318/340, de-interleaver block 342, adder blocks 344/346, subtractor blocks 348/350, flowcharts 400 and 500, and/or any further systems, sub-systems, and/or components disclosed herein may be implemented in hardware (e.g., hardware logic/electrical circuitry), or any combination of hardware with software (computer program code configured to be executed in one or more processors or processing devices) and/or firmware.

The embodiments described herein, including systems, methods/processes, and/or apparatuses, may be implemented using well known processing devices, telephones (smart phones and/or mobile phones), servers, and/or, computers, such as a computer 600 shown in FIG. 6. It should be noted that computer 600 may represent communication devices, processing devices, and/or traditional computers in one or more embodiments. For example, LTE architecture 200, JSCD block 300, and any of the sub-systems or components respectively contained therein may be implemented using one or more computers 600.

Computer 600 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Computer 600 may be any type of computer, including a desktop computer, a server, etc.

Computer 600 includes one or more processors (also called central processing units, or CPUs), such as a processor 606. Processor 606 is connected to a communication infrastructure 602, such as a communication bus. In some embodiments, processor 606 can simultaneously operate multiple computing threads.

Computer 600 also includes a primary or main memory 608, such as random access memory (RAM). Main memory 608 has stored therein control logic 624 (computer software), and data.

Computer 600 also includes one or more secondary storage devices 610. Secondary storage devices 610 include, for example, a hard disk drive 612 and/or a removable storage device or drive 614, as well as other types of storage devices, such as memory cards and memory sticks. For instance, computer 600 may include an industry standard interface, such a universal serial bus (USB) interface for interfacing with devices such as a memory stick. Removable storage drive 614 represents a floppy disk drive, a magnetic tape drive, a compact disk drive, an optical storage device, tape backup, etc.

Removable storage drive 614 interacts with a removable storage unit 616. Removable storage unit 616 includes a computer useable or readable storage medium 618 having stored therein computer software 626 (control logic) and/or data. Removable storage unit 616 represents a floppy disk, magnetic tape, compact disk, DVD, optical storage disk, or any other computer data storage device. Removable storage drive 614 reads from and/or writes to removable storage unit 616 in a well-known manner.

Computer 600 also includes input/output/display devices 604, such as touchscreens, LED and LCD displays, monitors, keyboards, pointing devices, etc.

Computer 600 further includes a communication or network interface 618. Communication interface 620 enables computer 600 to communicate with remote devices. For example, communication interface 620 allows computer 600 to communicate over communication networks or mediums 622 (representing a form of a computer useable or readable medium), such as LANs, WANs, the Internet, etc. Network interface 620 may interface with remote sites or networks via wired or wireless connections.

Control logic 628 may be transmitted to and from computer 600 via the communication medium 622.

Any apparatus or manufacture comprising a computer useable or readable medium having control logic (software) stored therein is referred to herein as a computer program product or program storage device. This includes, but is not limited to, computer 600, main memory 608, secondary storage devices 610, and removable storage unit 616. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic to implement, for example, JSCD block 216, turbo decoder 262, PRAB(s) 264, AMR 218, jitter buffer 256, decompression block 252, decryption block 244, cypher stream block 248, reordering and duplication detection block 240, turbo decoder 214, HARQ block 230, demodulator block 226, JSCD block 300, turbo decoder 352, first MAP decoder 302, second MAP decoder 304, first PRAB 306, first ASSA block 330, first PHSA block 332, second PRAB 308, second ASSA block 334, second PHSA block 336, interleaver blocks 318/340, de-interleaver block 342, adder blocks 344/346, subtractor blocks 348/350, flowcharts 400 and 500, and/or further embodiments described herein. Embodiments of the invention are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

### 11. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method for performing joint source channel decoding, comprising:
receiving a first plurality of soft bits representative of a first parameter included in a frame, each soft bit of the first plurality of soft bits specifying a probability that a corresponding bit of the first parameter is a zero or a one;
generating a second plurality of soft bits representative of the first parameter based on the first plurality of soft bits and at least one conditional probability based at least on a correlation of the first parameter and one or more other parameters included in the first frame and/or one or more parameters included in other frames, each soft bit of the second plurality of soft bits specifying a probability that a corresponding bit of the first parameter is a zero or a one; and
providing the second plurality of soft bits to a first channel decoder.

2. The method of claim 1, wherein receiving the first plurality of soft bits comprises receiving the first plurality of soft bits from a second channel decoder.

3. The method of claim 1, wherein the first parameter comprises a speech parameter.

4. The method of claim 3, wherein the speech parameter comprises at least one of pitch, pitch gain, fixed codebook gain, or linear spectral pairs.

5. The method of claim 1, wherein the first parameter comprises a packet field parameter.

6. The method of claim 5, wherein the packet field parameter comprises at least a portion of one of a media access control (MAC) header, a radio link control (RLC) header, a packet data convergence protocol (PDCP) header, a robust header compression (RoHC) header, a real-time protocol (RTP) header, or transport block padding.

7. The method of claim 1, wherein the first parameter comprises one of a predefined set of vectors and wherein generating the second plurality of soft bits comprises:
for each bit in the first parameter:
determining a probability associated with each vector in the set of vectors by:
applying a probability density function (PDF) to determine a first probability that the first parameter is equal to the vector given the value of the one or more other parameters included in the first frame and/or the one or more parameters included in the other frames;
multiplying the first probability by a second probability that the first parameter is equal to the vector given the value of the soft bits associated with the other bits in the first parameter; and
normalizing the product of the multiplying step; and
summing the probabilities associated with each vector in the set of vectors for which the bit in the vector is the same value as the bit in the first parameter.

8. The method of claim 7, wherein the PDF is a conditional PDF.

9. The method of claim 1, wherein the at least one conditional probability is further based on one or more conditions of a network over which the frame is received.

10. The method of claim 1, wherein the first channel decoder comprises a turbo decoder.

11. A system, comprising:
a first channel decoder; and
a packet redundancy analyzer configured to:
receive a first plurality of soft bits representative of a first parameter included in a frame, each soft bit of the first plurality of soft bits specifying a probability that a corresponding bit of the first parameter is a zero or a one,
generate a second plurality of soft bits representative of the first parameter based on the first plurality of soft bits and at least one conditional probability based at least on a correlation of the first parameter and one or more other parameters included in the first frame and/or one or more parameters included in other frames, each soft bit of the second plurality of soft bits specifying a probability that a corresponding bit of the first parameter is a zero or a one, and
provide the second plurality of soft bits to the first channel decoder.

12. The system of claim 11, further comprising a second channel decoder, wherein the first plurality of soft bits are received from the second channel decoder.

13. The system of claim 11, wherein the packet redundancy analyzer further comprises at least one of:
a speech block configured to generate the second plurality of soft bits, wherein the first parameter comprises a speech parameter, or
a packet field block configured to generate the second plurality of soft bits, wherein the first parameter comprises a packet field parameter.

14. The system of claim 13, wherein the speech parameter comprises at least one of pitch, pitch gain, fixed codebook gain, or linear spectral pairs, and
wherein the packet field parameter comprises at least a portion of one of a media access control (MAC) header, a radio link control (RLC) header, a packet data convergence protocol (PDCP) header, a robust header compression (RoHC) header, a real-time protocol (RTP) header, or transport block padding.

15. The system of claim 11, wherein the first parameter comprises one of a predefined set of vectors, and
wherein the packet redundancy analyzer is configured to generate the second plurality of soft bits by:
for each bit in the first parameter:
determining a probability associated with each vector in the set of vectors by:
applying a probability density function (PDF) to determine a first probability that the first parameter is equal to the vector given the value of the one or more other parameters included in the first frame and/or the one or more parameters included in the other frames;
multiplying the first probability by a second probability that the first parameter is equal to the vector given the value of the soft bits associated with the other bits in the first parameter; and
normalizing the product of the multiplying step; and
summing the probabilities associated with each vector in the set of vectors for which the bit in the vector is the same value as the bit in the first parameter.

16. The system of claim 15, wherein the PDF is a conditional PDF.

17. The system of claim 15, further comprising a memory configured to store the PDF.

18. The system of claim 11, wherein the at least one conditional probability is further based on one or more conditions of a network over which the frame is received.

19. The system of claim 11, wherein the first channel decoder comprises a turbo decoder.

20. A method for performing joint source channel decoding, comprising:
monitoring first data bits received over a channel;
generating one or more received statistics based on the monitored first data bits;
generating a conditional probability based exclusively on the one or more received statistics; and
utilizing the conditional probability to perform channel decoding of second data bits received over the channel.
